(19) United States
(12) Patent Application Publication
(10) Pub. No.: US 2010/0198626 A1
(43) Pub. Date: Aug. 5, 2010

(54) SYSTEMS AND METHODS FOR ACCESSING SHOPPING CENTER SERVICES USING A PORTABLE ELECTRONIC DEVICE

(75) Inventors: Christine Kim Cho, Cupertino, CA (US); Stanley Carl Ng, Los Altos, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/562,821

(22) Filed: Sep. 18, 2009

Related U.S. Application Data
(60) Provisional application No. 61/149,943, filed on Feb. 4, 2009.

(51) Int. Cl. G06Q 10/00; G06Q 50/00; G06Q 30/00

(52) U.S. Cl. 705/5; 705/10

(57) ABSTRACT

This is directed to systems and methods for enhancing a user's experience at a shopping center. In some embodiments, an integrated application available on an electronic device can provide information for promotional and available sales of goods and services, allow a user to browse and search through available content providers of the shopping center, such as parking, restaurants, and clothing stores, to purchase content based on the personal needs of a user. In some embodiments, an application available on an electronic device can check for the availability of particular items and show ratings or reviews for stores carrying the items. In some embodiments, In particular, the integrated application can provide a “heat map” to indicate popular areas of or items in a mall.

### CROSS-REFERENCE TO RELATED APPLICATIONS

This application claims the benefit of U.S. Provisional Patent Application No. 61/149,943, filed on Feb. 4, 2009, which is hereby incorporated by reference herein in its entirety.

### FIELD OF THE DISCLOSURE

This is directed to providing access to shopping mall services using a portable electronic device. In particular, this is directed to providing a “heat map” to indicate popular areas of or products in a mall.

### BACKGROUND OF THE DISCLOSURE

As shoppers visit shopping malls or various other types of consumer centers, many interactions between the shoppers and the shopping center can take place. For example, a shopper can interact with a parking lot attendant at the shopping center in order to find an available or most convenient parking space, can interact with a shopping mall map or information center to find stores of interest, can interact with a sales clerk to find an item of interest, can interact with magazines and brochures to try and determine what are popular items and stores, and can interact with restaurants and other services at the shopping center to reserve certain services. All of these interactions can require distinct actions from the shopper from different devices or elements. For example, a shopper can talk with a parking attendant, peruse a physical shopping mall directory, and use a phone to make restaurant reservations by calling a restaurant of choice.

Although this combination of approaches for interacting with a shopping center can be serviceable, it remains cumbersome and requires the shopping center to accommodate all of the possible forms of interaction. From a shopper's perspective, the lack of centralization of interactions with the shopping center provider and with the available shopping-related services can require more effort from the shopper wishing to take advantage of the shopping center, and perhaps even dissuade the shopper from using available services (thus at a cost to the shopping center provider).

Moreover, this approach may not provide a shopper with the most accurate information regarding what items or stores are popular. For example, a shopper may only have a magazine's or an advertisement's claim that a particular item is currently popular, and may not have any real world data on the popularity of that item (e.g., data such as how often the item is purchased).

### SUMMARY OF THE DISCLOSURE

This is directed to systems and methods for providing an integrated application on a portable electronic device for accessing shopping center services. Moreover, this is directed to an integrated application on a portable electronic device for providing a “heat map” to indicate popular areas of or items in a shopping center.

In some embodiments, the integrated application can interface with one or more service providers (e.g., vendors, shops, restaurants, parking lots, information centers, entertainment venues, or other suitable service providers) in the shopping center to provide access to different services and information made available by a shopping center. As one illustration, the integrated application can receive information from a server of a parking service provider to determine areas of available parking, available parking closest to a desired store, the location of a user's vehicle, or other suitable information related to parking. As another illustration, the integrated application can receive information related to movie times from a server of a movie theater service provider, can receive information related to store hours and available products from a vendor service provider, or receive any other suitable information.

In some embodiments, the integrated application can receive information from service providers that includes metadata associated with those service providers. The metadata can define, for example, attributes of the goods and services offered by a service provider (e.g., types of clothing, brands of clothing, color, how many of a particular item are currently in stock, types of food, or other suitable attributes), attributes of the service provider (e.g., type of store, hours of operation, location of the store in the shopping center) or any other suitable characteristic of a service provider. Using the metadata, the electronic device can compare goods and services from different stores or providers, and recommend combinations of goods from different stores or providers.

In some embodiments, the integrated application can provide personalized maps of a shopping center (e.g., maps showing a user's current location in real-time, a map showing preferred service providers, or other personalized map). In some embodiments, special promotions and offers can be received by a user's electronic device through the integrated application. In some embodiments, the integrated application can use the electronic device as a key to access certain goods or services provided by the shopping center service provider (e.g., a key to access to a shopping center's bathrooms, a key to access a specific parking space or elevator, a ticket to purchase a reserved item at a store, or the like).

The integrated application can interface with servers from several service providers to receive current information as to the availability and price of a particular product. For example, in response to a user selection of a particular item from a catalog displayed by the device, the electronic device can determine, from an appropriate source, the nearest store(s) carrying the item and the prices of the item in each of the stores. In addition to checking availability, the integrated application can provide a user with the ability to search for products, to reserve products (e.g., by pre-paying for an item), to locate stores or other service providers in a shopping center, or any combination of the above.

In some embodiments, the integrated application can map routes to a desired product. For example, in response to a user indicating they desire “Product A”, the integrated application can locate a store currently possessing Product A, and then display a map showing a route from the user's current location to the located store. As another example, in response to a user indicating they desire several products, the integrated application can locate one or more stores currently possessing these products, and then generate a route through the shopping center that can bring the user to each of the stores. The generated route may, for example, be a shortest route that takes the user to the stores, a route the allows the user to end at a desired location (e.g., the user may desire to end their shopping near a Food Court so they can eat, or the user may desire to end their shopping near an exit to a parking lot), or any other suitable route.

To assist users in purchasing new content at the shopping center, the integrated application can provide product recommendations based on user preferences. For example, the integrated application can compare a database of user preferences to information related to new products to determine whether there are any matches. As another example, the integrated application can include or access a database storing information reflecting the items already owned by the user. The integrated application may then compare new items in the shopping center with the items already owned by the user, and provide recommendations to a user based on these comparisons.

In some embodiments, a “heat map” can be provided to indicate the popularity of a service provider, product, or both to a user. For example, the integrated application can receive information related to stores in which a lot of customers are currently purchasing items, or related to the number of a particular product that is being purchased. Based on this information, the integrated application can then determine which service providers, products, or both are currently popular (e.g., where a product or service provider can be considered more popular when more people are buying this product or making purchases at this store, respectively). The integrated application may then generate a heat map to symbolically display the popularity of service providers, products, or both to a user.

### BRIEF DESCRIPTION OF THE DRAWINGS

The above and other features of the invention, its nature and various advantages will be more apparent upon consideration of the following detailed description, taken in conjunction with the accompanying drawings in which:

FIG. 1 shows a schematic view of an illustrative electronic device for providing an application operative to interface with a shopping center system in accordance with some embodiments of the invention;

FIG. 2 shows a schematic diagram of advantages of an integrated application for enhancing a user's shopping center experience in accordance with some embodiments of the invention;

FIG. 3 shows a schematic view of functions available to a user while finding a parking space at a shopping center in accordance with some embodiments of the invention;

FIG. 4 shows a schematic view of functions available to a user while generally browsing for goods and services at a shopping center in accordance with some embodiments of the invention;

FIG. 5 shows a schematic view of functions available to a user while searching for goods and services at a shopping center in accordance with some embodiments of the invention;

FIG. 6 shows an exemplary user interface that can provide notification of friends' locations in accordance with some embodiments of the invention;

FIG. 7 shows an exemplary heat map to indicate popularity of products and/or vendors in a shopping center in accordance with some embodiments of the present invention;

FIG. 8 shows an exemplary process for creating a heat map in accordance with some embodiments of the present invention; and

FIG. 9 shows a schematic view of functions available to a user while searching for a restaurant at a shopping center in accordance with some embodiments of the invention.

### DETAILED DESCRIPTION OF THE DISCLOSURE

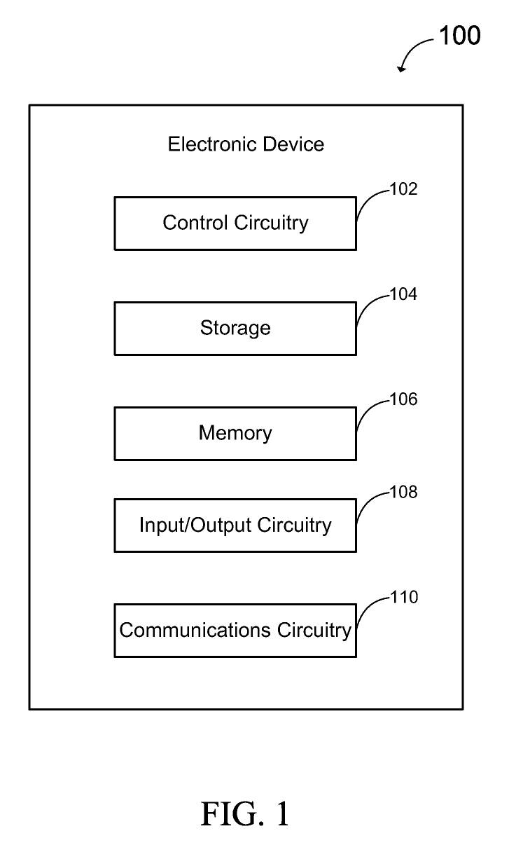

FIG. 1 is a schematic view of an illustrative electronic device for providing an application operative to interface with a shopping center system in accordance with some embodiments of the invention. Electronic device 100 can include control circuitry 102, storage 104, memory 106, input/output (“I/O”) circuitry 108, and communications circuitry 110. In some embodiments, one or more of the components of electronic device 100 can be combined or omitted (e.g., storage 104 and memory 106 may be combined). In some embodiments, electronic device 100 can include other components not combined or included in those shown in FIG. 1 (e.g., motion detection components, a power supply such as a battery or kinetics, global positioning system, a display, bus, or input mechanism, etc.), or several instances of the components shown in FIG. 1. For the sake of simplicity, only one of each of the components is shown in FIG. 1.

Electronic device 100 can include any suitable type of electronic device. For example, electronic device 100 can include a portable electronic device that the user may hold in his or her hand, such as a digital media player (e.g., an iPod™ made available by Apple Inc. of Cupertino, Calif.), a personal e-mail device (e.g., a Blackberry™ made available by Research in Motion of Waterloo, Ontario), a personal data assistant (“PDA”), a cellular telephone, a handheld gaming device, and a digital camera. As another example, electronic device 100 can include a larger portable electronic device, such as a laptop computer. As yet another example, electronic device 100 can include a substantially fixed electronic device, such as a desktop computer.

Processor or control circuitry 102 can include any processing circuitry or processor operative to control the operations and performance of electronic device 100. For example, control circuitry 102 can be used to run operating system applications, firmware applications, media playback applications, media editing applications, or any other application. In some embodiments, control circuitry 102 can drive a display and process inputs received from a user interface of electronic device 100.

Storage 104 can include, for example, one or more storage mediums including a hard-drive, solid state drive, flash memory, permanent memory such as read-only memory (“ROM”), any other suitable type of storage component, or any combination thereof. Storage 104 can store, for example, media data (e.g., music and video files), application data (e.g., for implementing functions on electronic device 100), firmware, user preference information data (e.g., media playback preferences), authentication information (e.g., libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable electronic device 100 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

Memory 106 can include cache memory, semi-permanent memory such as random-access memory (“RAM”), and/or one or more different types of memory used for temporarily storing data. In some embodiments, memory 106 can also be used for storing data used to operate electronic device applications, or any other type of data that can be stored in storage 104. In some embodiments, memory 106 and storage 104 can be combined as a single storage medium.

Input/output (“I/O”) circuitry 108 can be operative to convert (and encode/decode, if necessary) analog signals and other signals into digital data. In some embodiments, I/O circuitry 108 can also convert digital data into any other type of signal, and vice-versa. For example, I/O circuitry 108 can receive and convert physical contact inputs (e.g., from a multi-touch screen), physical movements (e.g., from a mouse or sensor), analog audio signals (e.g., from a microphone), or any other input. The digital data can be provided to and received from control circuitry 102, storage 104, memory 106, or any other component of electronic device 100. Although I/O circuitry 108 is illustrated in FIG. 1 as a single component of electronic device 100, several instances of input/output circuitry can be included in electronic device 100.

Electronic device 100 can include any suitable interface or component for allowing a user to provide inputs to I/O circuitry 108. For example, electronic device 100 can include any suitable input mechanism, such as for example, a button, keypad, dial, a click wheel, or a touch screen. In some embodiments, electronic device 100 can include a capacitive sensing mechanism, or a multi-touch capacitive sensing mechanism.

In some embodiments, electronic device 100 can include specialized output circuitry associated with output devices such as, for example, one or more audio outputs. The audio output can include one or more speakers (e.g., mono or stereo speakers) built into electronic device 100, or an audio component that is remotely coupled to electronic device 100 (e.g., a headset, headphones or earbuds that can be coupled to electronic device 100 with a wire or wirelessly).

In some embodiments, I/O circuitry 108 can include display circuitry (e.g., a screen or projection system) for providing a display visible to the user. For example, the display circuitry can include a screen (e.g., an LCD screen) that is incorporated in electronic device 100. As another example, the display circuitry can include a movable display or a projecting system for providing a display of content on a surface remote from electronic device 100 (e.g., a video projector). In some embodiments, the display circuitry can include a coder/decoder (“CODEC”) to convert digital media data into analog signals. For example, the display circuitry (or other appropriate circuitry within electronic device 100) can include video CODECS, audio CODECS, or any other suitable type of CODEC.

The display circuitry also can include display driver circuitry, circuitry for driving display drivers, or both. The display circuitry can be operative to display content (e.g., media playback information, application screens for applications implemented on the electronic device, information regarding ongoing communications operations, information regarding incoming communications requests, or device operation screens) under the direction of control circuitry 102. Alternatively, the display circuitry can be operative to provide instructions to a remote display.

Communications circuitry 110 can include any suitable communications circuitry operative to connect to a communications network and to transmit communications (e.g., voice or data) from electronic device 100 to other devices within the communications network. Communications circuitry 110 can be operative to interface with the communications network using any suitable communications protocol such as, for example, Wi-Fi (e.g., a 802.11 protocol), Bluetooth™, radio frequency systems (e.g., 900 MHz, 1.4 GHz, and 5.6 GHz communication systems), infrared, GSM, GSM plus EDGE, CDMA, quadband, and other cellular protocols, voice over internet protocol (“VOIP”), or any other suitable protocol.

In some embodiments, communications circuitry 110 can be operative to create a communications network using any suitable communications protocol. For example, communications circuitry 110 can create a short-range communications network using a short-range communications protocol to connect to other devices. For example, communications circuitry 110 can be operative to create a local communications network using the Bluetooth™ protocol to couple electronic device 100 with a Bluetooth™ headset. In some embodiments, a communications network may be enabled by a travel service provider (e.g., a pre-approved Wi-Fi network on an airplane during flight, perhaps for a fee).

Electronic device 100 can include one more instances of communications circuitry 110 for simultaneously performing several communications operations using different communications networks, although only one is shown in FIG. 1 to avoid overcomplicating the drawing. For example, electronic device 100 can include a first instance of communications circuitry 110 for communicating over a cellular network, and a second instance of communications circuitry 110 for communicating over Wi-Fi or using Bluetooth™. In some embodiments, the same instance of communications circuitry 110 can be operative to provide for communications over several communications networks.

In some embodiments, electronic device 100 can be coupled to a host device for data transfers, synching the communications device, software or firmware updates, providing performance information to a remote source (e.g., providing characteristics to a remote server) or performing any other suitable operation that can require electronic device 100 to be coupled to a host device. Several electronic devices 100 can be coupled to a single host device using the host device as a server. Alternatively or additionally, electronic device 100 can be coupled to several host devices (e.g., for each of the plurality of the host devices to serve as a backup for data stored in electronic device 100).

Electronic device 100 may include an application operative to interface with one or more systems (e.g., shopping center “service provider” systems) to provide access to different services and different information made available by a shopping center service provider. As used herein, the term “service provider” can refer to any suitable service provider that can be associated with or located in a shopping center. For example, service providers can include stores in a shopping center, restaurants in a shopping center, kiosks in a shopping center, other vendors in the shopping center, parking lots in a shopping center, information desks in a shopping center, entertainment venues in a shopping center (e.g., a movie theater, an ice skating rink, or any other entertainment venue), or any other suitable service provider.

As one example of interfacing with service providers of a shopping center, the integrated application can connect to one or more parking servers of a parking service provider to receive data reflecting nearest available parking to the shopper, the location of most available parking, the location of a shopper-specific parking location (e.g., the location of where the shopper parked their car), or any combination of the above. As another example, the application can connect to one or more shopping center vendor servers at the shopping center to receive data reflecting a shopper's current location with respect to open stores in the shopping center, new stores in the shopping center since the shopper's last visit, and the like. As another example, the application can connect with distinct servers associated with attractions or shops proximate the shopper's current location (e.g., restaurants near a shop of interest to the shopper) for which the user can make reservations, purchases, or access information using the interface of the electronic device.

In this manner, an electronic device (e.g., electronic device 100 of FIG. 1), can allow a user to perform a variety of different operations to enhance the user's shopping center experience. In some embodiments, these different functions can be provided through a single, integrated application of the electronic device. For example, a single, integrated application could be used while the user is searching for parking at a shopping center, while the user is searching for vendors of various types, while the user is searching for locations of general goods and services available at the shopping center, and while the user is making reservations at a restaurant or other vendor. Moreover, although specific examples are listed above, one skilled in the art could appreciate that a user can make use of a single, integrated application in any suitable situation in the context of a shopping center experience. Also, in addition to shopping centers, it is to be understood that a user can make use of a single, integrated application in the context of any other type of multi-service provider experience, in accordance with other embodiments of the invention.

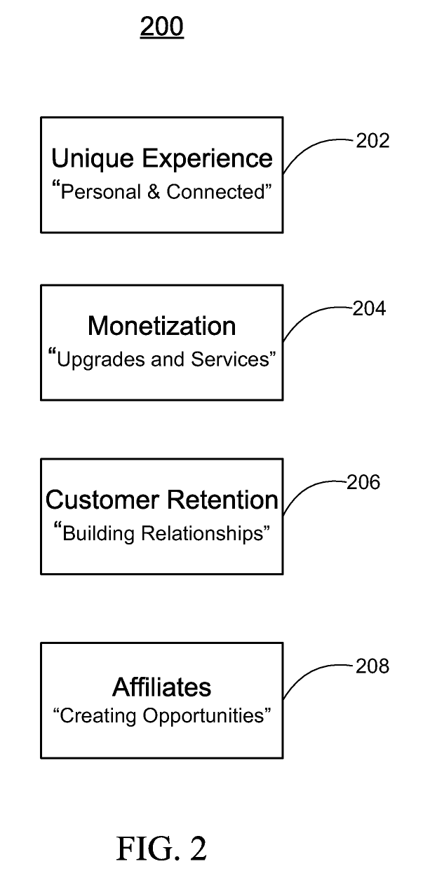

Advantages of such a single, integrated application can include, as indicated by diagram 200 of FIG. 2, creating a unique experience 202. For example, the integrated application can create a shopping center experience that is personal and connected to a shopper (e.g., by promoting continuity with a certain shopping center based on a shopper's personal preferences and habits). Advantages of a single, integrated application may also include monetization 204. For example, upgrades and special services that may be purchased by a user can be offered through the integrated application. Another advantage can include customer retention 206. For example, the integrated application can build customer relations and promote customer retention (e.g., by addressing a shopper's needs 24 hours a day and 7 days a week to provide the utmost satisfaction). Yet another advantage can include affiliate opportunities 208. For example, since a portable electronic device's simplicity, affordability, and portability may appeal to a broad scope of shoppers, a broad scope of shoppers may be using the integrated application. Affiliate companies may then be given the opportunity to reach this wide range of shoppers through the integrated application. In this manner, a single, integrated application can control and enhance the user's experience with the shopping center's available service providers.

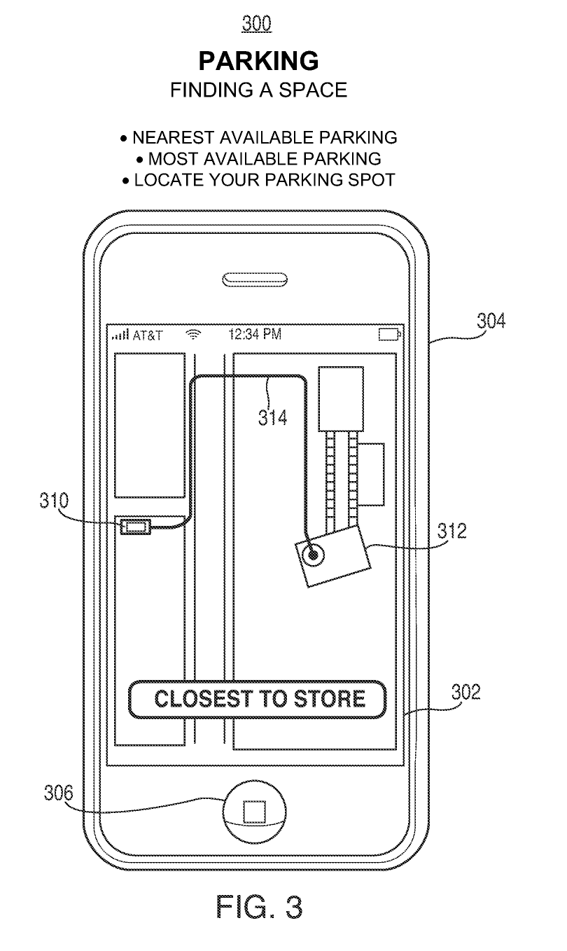

FIG. 3 shows diagram 300 of various functions available to a user while finding a parking space (e.g., a parking space at a shopping center or any other area requiring parking) in accordance with some embodiments of the invention. For example, to provide the functions indicted by diagram 300, an integrated application of a shopper's electronic device (e.g., electronic device 100 of FIG. 1) can connect to a server of a parking service provider. Information associated with the functions of diagram 300 can then be received from this server. As indicated in diagram 300, the application may allow a user to search for the nearest available parking, find the area with the most available parking, find the location of a user's parking space (e.g., as a user is returning to his or her parked car), or perform any other suitable operations related to locating parking.

In some embodiments, the integrated application can allow a user to perform secure transactions (e.g., using a credit card) to reserve and/or pay for a parking space. However, one skilled in the art could appreciate the integrated application may be used to perform secure transactions for any suitable service and is not restricted to a parking service. For example, in some embodiments, the integrated application can allow a user to perform secure transactions to reserve and/or pay for other shopping center services such as accessing a private bathroom, using a specific type of shopping cart or shopping attendant, purchasing movie tickets, reserving a table at a restaurant, purchasing or reserving other products, or any other suitable services.

As another example, user interface 302 shows an exemplary interface that can be provided by an integrated application of electronic device 304. As illustrated by user interface 302, the integrated application can aid a user in locating a parking spot that is closest to a desired store. For example, a user can enter a desired store through any suitable input of electronic device 304, such as input 306. The integrated application may then determine an available parking spot that is closest to the desired store (e.g., by analyzing information received from a server of a parking service provider of the shopping center). The integrated application can then display a map indicating the determined parking spot 310, desired store 312, and route 314 from parking spot 310 to desired store 312. In this manner, through the integrated application, the shopping center's parking service provider can provide a unique experience that is personalized for the user and can help the shopping center remain connected with the user.

In some embodiments, the integrated application can allow the electronic device to function as a “parking ticket.” For example, an electronic device using the integrated application can have a display operable to show a specific optical pattern (e.g., a barcode, or other suitable optical pattern operable to store information). The optical pattern can be scanned by the parking service provider to allow the user to access various functions such as opening a gate to enter a parking lot (e.g., when the user has a car parked in that parking lot), allowing the user to pay when removing their car from a parking lot (e.g., where the optical pattern can contain information associated with how long the user was parked in the parking lot), or any other suitable function.

In some embodiments, the integrated application can receive information from services providers at the shopping center, where the information includes metadata related to the service provider itself. The metadata can define, for example, attributes of the goods and services available, such as the type of service provider (e.g., men's clothing store, women's clothing store, electronics store, movie theater, parking lot, or other suitable type of service provider), location of the store in the shopping center, hours of operation, or any other suitable characteristic of a service provider. Moreover, the integrated application can receive metadata from services providers that is related to the goods and services provided by the service provider. This metadata can define, for example, attributes of the goods and services available, such as the item, color, collection, type or style of clothing or other product, or any other suitable characteristic of the goods or services available (e.g., menu of a restaurant at the shopping center). Using the metadata, the integrated application can, for example, compare goods and services from different stores or providers, recommend combinations of goods from different stores or providers, display maps showing the locations of goods and services in a shopping center, or perform any other suitable function.

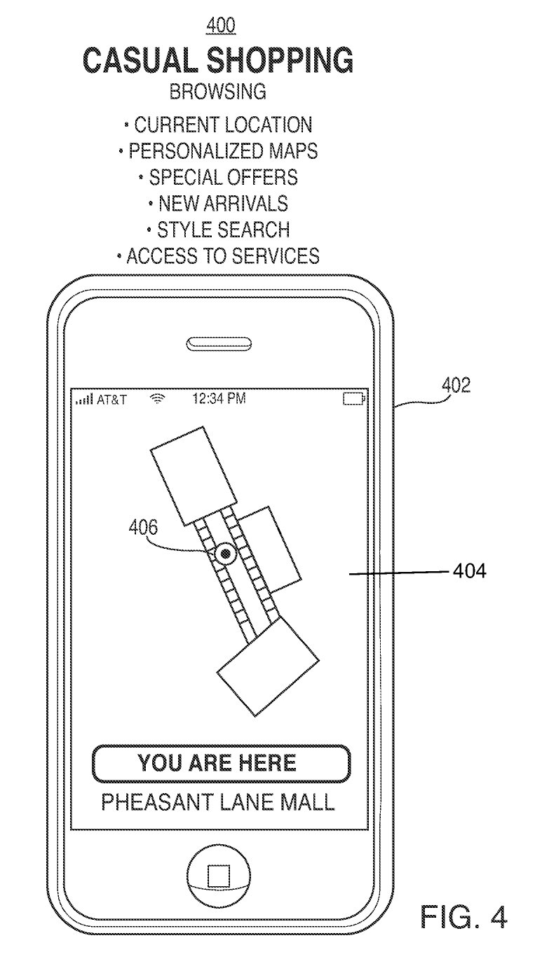

FIG. 4 is a schematic view of functions available to a user while generally browsing for goods and services at a shopping center in accordance with some embodiments of the invention. As shown in diagram 400, a user can determine their current location with respect to the various shops in the shopping center. For example, the user's electronic device can be connected to and authenticated by a wireless network provided by the shopping center. Any suitable triangulation technique can be used in conjunction with measurements from various wireless network access points (e.g., hotspots) in the vicinity to determine the user's location with respect to the shopping center. Alternatively, any other suitable positioning system can be used to determine the user's geographic location such as a global positioning system (“GPS”), a system using a trilateration technique, a system that measures various signal-to-noise ratios of various cellular network signals, or any other suitable positioning system. As used herein, the term “positioning system” can refer to any suitable system of an electronic device for determining the location of a user of the electronic device such as, for example, a GPS, systems using triangulation or trilateration techniques, or any other suitable positioning system.

As is also indicated in diagram 400, an integrated application can allow a shopper to receive personalized maps to various goods and services providers (e.g., using an integrated or associated mapping application). The map can be personalized based on, for example, the location of the user, availability of a desired item, age of the store, type of the store, on-going sales in the shopping center, user-preferences (e.g., by displaying user-preferred stores more prominently), and the like. For example, FIG. 4 shows an illustrative electronic device 402 that can display personalized map 404. Personalized map 404 may, for example, show a user's location 406 with respect to stores in the shopping center in real-time (e.g., the user's location on the map can update in real-time as the user moves through the shopping center). A map such as personalized map 404 may, for example, beneficially reduce crowding near mall directories or eliminate a shopper's need to wander a shopping center in search of a mall directory (e.g., since the shopper has a convenient, personalized map on hand through their portable electronic device). In some embodiments, a personalized map such as personalized map 404 can indicate a shopper's location with respect to open stores, with respect to new stores that have opened since the shopper's last visit to the shopping center, with respect to preferred stores, or any combination of the above.

As is also indicated in diagram 400, in some embodiments a shopper can receive special offers from various stores that may be of interest to the user through the integrated application. For example, the integrated application can access a listing of user preferences. These user preferences can define that a user prefers, for example, a particular brand, a particular type of good (e.g., women's shoes, action movies, new arrivals, or any other type of good), a particular price range, a particular service provider, or any other suitable preferences. Promotions that match the user's preferences can then be received through the integrated application of the user's electronic device. For example, metadata defining the promotions can be compared to the user preferences to determine whether there is a match. The integrated application may then deliver these preferences to the user in any suitable fashion. For example, the promotions can be shown on a display of the user's electronic device, a push-notification can be delivered to the user's electronic device, an e-mail can be sent to the user's e-mail account, or any other suitable way can be used to notify the user of the matching promotions. The notifications of the promotions can be provided when the user enters the shopping center, when the user enters a particular store of the shopping center, on a periodic basis, or at any other suitable time.

Moreover, through the integrated application, service providers of the shopping center can provide time-sensitive sale information to the electronic device to incite buyers to come to stores to take advantage of these limited offers (e.g., inform a buyer of a sale lasting only two hours at a particular store). In addition, using historical data to identify buying trends of particular user, service providers can provide personalized offers directly to the user's electronic device. For example, a service provider can analyzer historical data of a shopper to determine the shopper prefers a certain brand of shoes. The service provider can then send promotions to the shopper's electronic device that are associated with this preferred brand of shoes.

As indicated in diagram 400, in some embodiments the electronic device can be used to interface with a menu providing access to certain services available at the shopping center. For example, the integrated application can generate a menu on the electronic device providing access to services such as renting and reserving shopping carts, hailing a bell-hop (e.g., to help load merchandise into a customer's shopping cart or car), viewing menus of restaurants, viewing products available by service providers, or any other suitable service. Using the menu, the user can, for example, order services or reserve goods for purchase.

In some embodiments, the integrated application can provide a user with an electronic key or ticket to various available goods and services of the shopping center, such as access to a private bathroom, a receipt for picking up pre-purchased items (e.g., a pre-purchased movie ticket, an article of clothing bought on-line, a ticket to pick up dry cleaning, or the like), or any other suitable electronic ticket. For example, the electronic device can transmit a signal using an appropriate protocol and radio (e.g., a radio-frequency identification (“RFID”) signal or other near field communication) to direct a door to be opened or to direct other types of access to be granted. As another example, the electronic device can display a pattern for an optical reader associated with a door or gate (e.g., display a barcode). Alternatively, the electronic device can produce any other signal that can be read by a suitable sensor. The electronic device can receive the appropriate electronic key at any suitable time, for example upon arriving at a specific store or parking space, when dropping off dry-cleaning, when purchasing a movie ticket, or at any other suitable time.

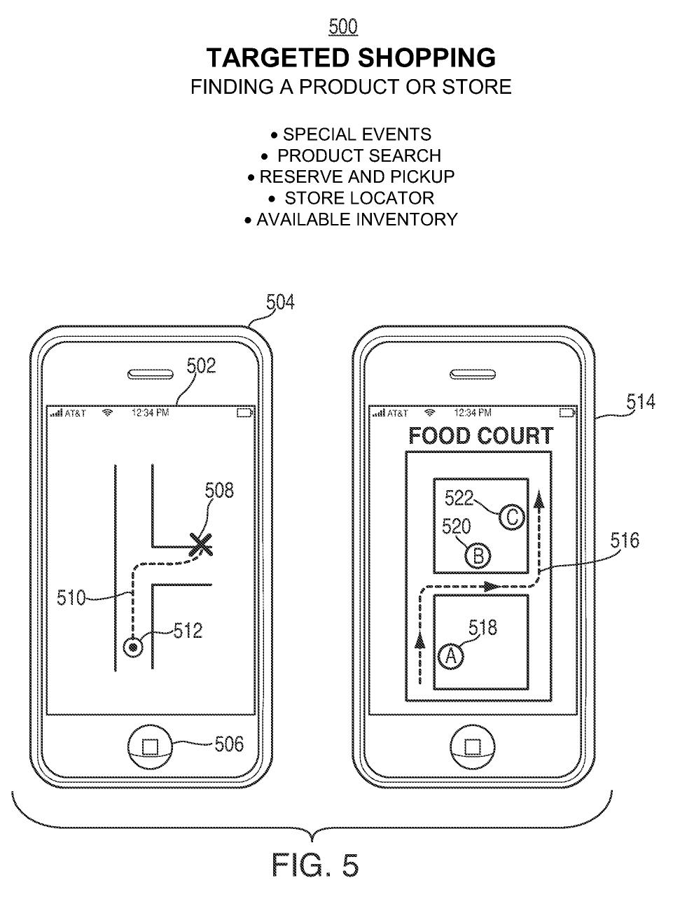

FIG. 5 is a schematic view of functions available to a shopper while searching for goods and services at a shopping center in accordance with some embodiments of the invention. In some embodiments, the functions indicated by diagram 500 can relate to “targeted shopping,” such as when a shopper is searching for a particular item or type of item rather than casually browsing (e.g., when the shopper is searching for a new dress for a party, or when the shopper is searching for the newest Tom Clancy novel). However, one skilled in the art could appreciate that the functions indicated by FIG. 5 are not limited to targeted shopping, and rather may be available through an integrated application in any suitable shopping center scenario.

As shown in display 500, the integrated application could be used to provide recommendations of what to buy and where to buy the recommended items, identify sales, determine the availability of specific items, compare new items with the items already owned by the user, and monitor the latest trends to ensure that purchases are as desired. By providing a single application having access to information from one or more services providers at a shopping center, the integrated application provider can control and enhance the user's experience with the shopping center's available content providers. For example, the shopping center provider can provide a unique brand experience that is personalized and maintained by remaining connected with the user, monetizing the user's experience, building relationships with a user to retain customers, and creating affiliate opportunities.

As indicated in diagram 500, the integrated application can provide promotions and invitations to special events (e.g., general events for a specific subset of customers or stores, or a personalized event particular to a certain shopper) and the ability to search and browse products of service providers. For example, a user can browse a particular store's product catalogue and/or select products from that store's catalogue on the user's electronic device (e.g., electronic device 100 of FIG. 1). In some embodiments, in response to a user selecting a particular product of a store (e.g., from a catalogue displayed on the electronic device), competing stores with the same or a comparable product can send a notification to the user regarding their product. For example, a competing store can notify a user that they have the same selected product for a cheaper price. As is also indicated in diagram 500, the integrated application can provide a user with the ability to pre-order or reserve products of interest (e.g., reserve a product in a particular size), can provide a store locator for the user, or any combination of the above.

In some embodiments, an integrated application can allow a shopper to check product availability or browse products. For example, the electronic device can display a catalogue or listing of products available in the shopping center or available in a particular store of the shopping center. In response to receiving a user selection of a particular product, the electronic device can determine information such as the nearest store(s) that has this product in stock and the prices of the product in each of the stores. To determine such information, the integrated application may, for example, interface with servers from service providers of the shopping center to receive current information related to the availability and price of a particular product. In some embodiments, a user can purchase a item (e.g., a selected item of the catalogue) through the integrated application (e.g., by entering payment information through a secure server).

In some embodiments, the integrated application can route maps to desired products. For example, user interface 502 shows an exemplary interface that can be generated by an integrated application of electronic device 504. A user can enter a desired product through any suitable input of electronic device 504, such as input 506. The integrated application can then determine the location of store 508 in which the desired product is available (e.g., determined by communicating with a product server of the store). Route 510 can be displayed showing a route from the user's current location 512 to store 508. A desired product may, for example, be a specific item (e.g., the novel “Jurassic Park” by Michael Crichton) or a general type of item (e.g., a pair of black boots).

In some embodiments, the integrated application can generate a path through a shopping center that can bring a user to several desired products. For example, a user can indicate that they desire to find Products A, B, and C. The integrated application can then determine stores in the shopping center that currently have one or more of Products A, B, and C. For example, the integrated application can communicate with various product servers of the stores to determine whether they have the desired products in stock. The integrated application can then generate a map of the shopping center that indicates the locations of Products A, B, and C, and a suitable route to get to these items. For example, map 514 shows an illustrative map that can be generated by the integrated application. Map 514 can indicate route 516 that a shopper can follow to arrive at stores having, respectively, Product A 518, Product B 520, and Product C 522. Route 516 can be determined in any suitable manner. For example, route 516 can be determined as the shortest path possible that can bring a user to Products A, B, and C. As another example, route 516 can be determined such that the user's final destination is near a desired location. For example, the user may desire to end their shopping near a Food Court so they can get dinner, or the user may desire to end their shopping near the parking lot in which their car is parked. Accordingly, in this scenario, route 516 can be determined such that the user is located near, respectively, a food court or the user's parking lot at the end of route 516.

In some embodiments, the integrated application could be used to provide recommendations of products to buy and information on where to buy these recommended items. For example, the integrated application can access a listing of user preferences. Based on the user preferences, the integrated application can determine products that may interest the user. For example, the integrated application can compare user preferences to metadata associated with products of the service providers in the shopping center. In response to a user preference matching metadata of a product (e.g., a user preference indicates the user prefers small, black, handbags and the metadata of a store's product indicates this product is a small, black handbag), the integrated application can send a notification to the user of this match. The integrated application can also send any suitable information related to this matching product to the user such as, for example, a picture of the product, a description of the product, the price of the product, the name of the store in which the product is located, a map showing a route to the store in which the product is located, the store hours of this store, or any other suitable information.

In some embodiments, to assist users in purchasing new content at the shopping center, the integrated application can include or access a database storing information reflecting the items already owned by the user. The user can initially populate the database of owned items by taking images of the items, finding the items from historical databases of products, by entering identifying information for each product, or the like. In some embodiments, the electronic device can automatically update the database by including items purchased by the user (e.g., as determined from a communication between the goods and services content providers and the electronic device, or from a payment source used to purchase the items and the electronic device). The integrated application may then compare new items in the shopping center with the items already owned by the user, and provide recommendations to a user based on these comparisons. For example, the integrated application can provide notifications of new items that are similar to items currently owned by a user (e.g., and thus may match the user's preferences or tastes).

Moreover, through an integrated application, a user can rate and review stores, rate and review goods and services, build customized shopping lists using newly purchased items, set personalized alerts for desirable new merchandise, receive promotions and invitations for further personalization based on the user's purchases, and any combination of the above. In some embodiments, the personalized alerts can include alerts for items deemed to be of interest to the user based on previous purchases, items completing or complementing other purchases (e.g., clothing to complete an outfit), and the like. In some embodiments, alerts can be provided to recommend items needed for a special occasion retrieved from a user's calendar (e.g., recommend a dress for attending a wedding scheduled in the next month in the user's calendar).

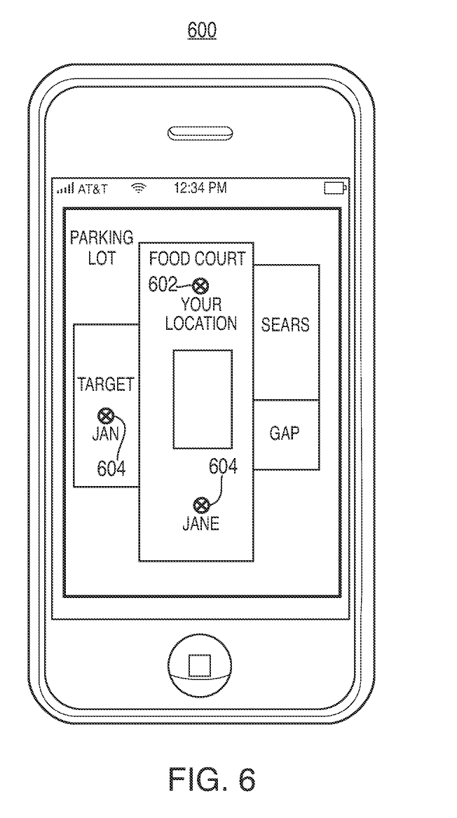

In some embodiments, the integrated application may build social networking connections by providing notification of friends' locations in a shopping center. For example, each friend may have on their person an electronic device that includes a positioning system. The positioning system can be any suitable system (e.g., GPS, or a system using triangulation of wi-fi or cellular network signals) that can determine the friend's location. The friend's location may then be transmitted to the user's electronic device. The user's electronic device may then create a personalized map of the shopping center indicating the user's location and the locations of the friends. For example, FIG. 6 shows exemplary user interface 600 that can provide notification of friends' locations. As shown in FIG. 6, a user's current location in a shopping center can be indicated by marker 602, and the locations of friends can be indicated by one or more instance of marker 604.

Moreover, through the integrated application, social networking connections may also be built by allowing a user and friends to share ideas and opinions related to the shopping center. For example, the user can share opinions on products and stores, ask for recommendations on products and stores, post information related to the shopping center to a public “wall,” blog, or other on-line information sharing site, or any combination of the above.

Accordingly, through an integrated application, a user can receive advice regarding popular items, receive gift guides, generate and update a wish list and a look book, and use social networking features to request and receive advice from friends or other users in a social network. A user can scan for information and ratings for particular items, check availability of items in one or more sizes, compare fashion items, and build outfits. The electronic device can include one or more algorithms operative to recommend products to generate complete shopping center purchase experiences using items from several service providers of the shopping center as well as items already in the user's possession.

In some embodiments, an integrated application can keep a user informed of what products, stores, or both in a shopping center are currently popular. As one illustration, the integrated application can receive information related to sales information of products in the shopping center. For example, by communicating with various servers of service providers in the shopping center, the integrated application can receive information related to what products have been sold and in what quantity. In this manner, the integrated application can determine what products, stores, or both are popular by analyzing the sales information received from the service providers of the shopping center.

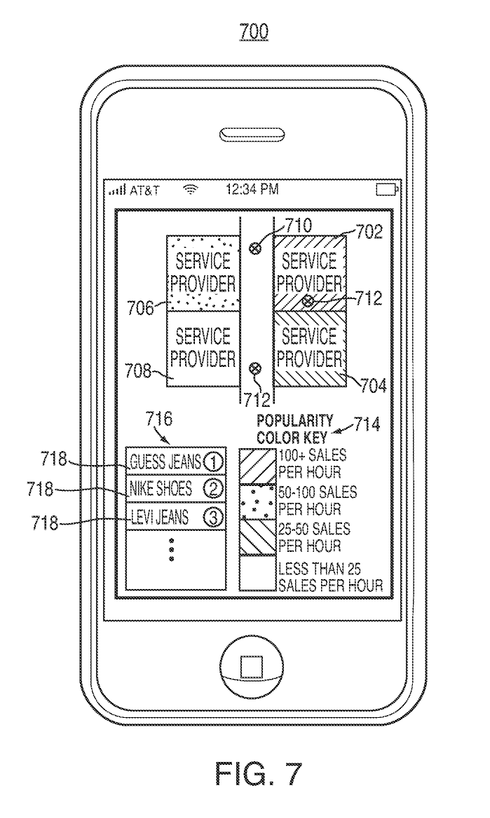

In some embodiments, the integrated application can provide a “heat map” to indicate to the user what products and stores are currently popular. For example, FIG. 7 shows illustrative heat map 700 in accordance with some embodiments of the present invention. Heat map 700 may, for example, be displayed on a display of an electronic device (e.g., electronic device 100 of FIG. 1) through the integrated application. Heat map 700 may indicate the locations of one or more service providers within the shopping center such as service providers 702, 704, 706, and 708. The service providers can be any suitable service providers such as, for example, a store, a restaurant, a kiosk, an other type of vendor, a parking lot, an information desk, an entertainment venue, or any other suitable service provider. For the sake of simplicity, four instance of a service provider are shown in FIG. 7, however one skilled in the art could appreciate that any suitable number of service providers could alternatively be indicated in heat map 700.

In some embodiments, the user's current position can be indicated by marker 710 on heat map 700. Marker 710 can update in real-time to reflect the user's position as the user moves through the shopping center. In some embodiments, one or more friend markers 712 can indicate the location of friends and acquaintances within the shopping center.

As mentioned above, the integrated application can receive information related to the sale of products in the shopping center. For example, the integrated application can communicate with one or more servers of service providers to receive real-time information of products that service providers has sold. In addition to receiving information related to the number of a product sold, the integrated application can alternatively or additionally receive metadata associated with the product that can define, for example, the type of product, the store selling the product, the color of the product, the brand of the product, or any other suitable data. Based on this received data, the integrated application can then generate heat map 700 to indicate the popularity of a product, store or both, for example, by indicating what stores are currently selling a lot of products or by indicating what products shoppers are currently purchasing.

In this manner, by providing current, real world data on the sales information of products, a user can be accurately informed of popularity and trends though heat map 700. Heat map 700 may provide more accurate popularity information than, for example, a magazine or advertising. For example, an advertisement may claim a particular product is popular, but a user may be uncertain whether this claim is true or not. However, through heat map 700, a user may accurately be informed that a store (e.g., or a product) is popular by seeing real world data indicating a large number of people are currently purchasing items from this store (e.g., or purchasing this product).

In some embodiments, the popularity (e.g., the amount of sales) of a service provider can be indicated through a coloring scheme. For example, the various service providers can each be filled with a color that indicates the popularity of the service provider. To decipher the colors, a color key 714 can be provided on heat map 700. Alternatively, rather than colors, various markers, emblems, or any other suitable indicator can be used to define the popularity of a particular service provider.

Moreover, in addition to or instead of indicating the popularity of a particular service provider, the popularity of a particular product can be indicate by heat map 700. For example, based on sales information of products (e.g., sales information received from a server of a service provider of the shopping center), heat map 700 can indicate the popularity of products in any suitable manner. For example, in some embodiments chart 716 can be provided that shows a listing of products and their popularity level. Chart 716 can display product information 718 of various products available in the shopping center. Product information 718 can include information such as, for example, a product name, product description, product popularity level, number of this product sold in the last hour (e.g., or other appropriate amount of time), product picture, stores selling this product, any other suitable product information, or any combination of the above.

In some embodiments, heat map 700 can be configured based on user preferences. For example, user preferences can define that the user prefers a particular service provider, prefers a particular brand, prefers a particular type of product, prefers products having at least a minimum popularity level, or any other suitable preferences. Heat map 700 can then be configured such that products, service providers, or both that match the user preferences are displayed more prominently. For example, if the user preferences define that the user prefers the brand, “American Eagle,” than products provided by American Eagle can be shown more prominently (e.g., shown at the top of lists, shown in bold, shown in brighter colors, or otherwise shown more prominently). In some embodiments, in this scenario only products from American Eagle may be indicated by heat map 700.

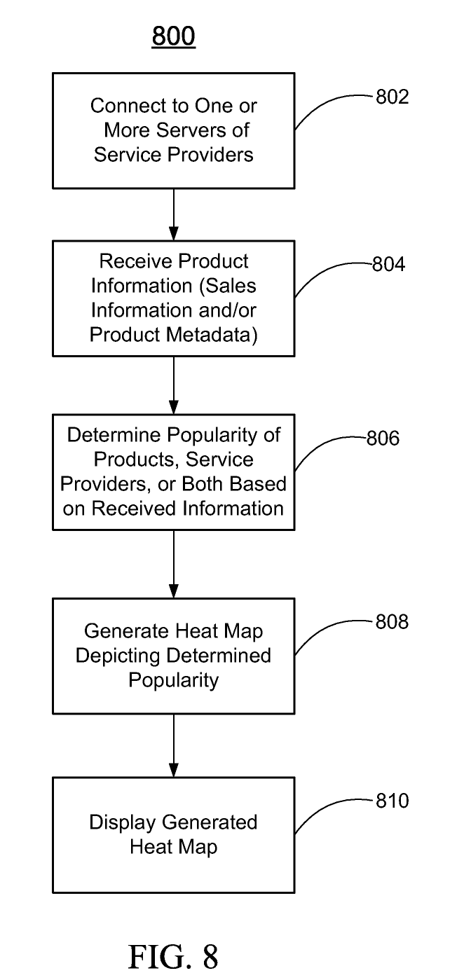

FIG. 8 shows process 800 for creating a heat map such as, for example, heat 700 of FIG. 7. At step 802, an integrated application of a user's electronic device (e.g., electronic device 100 of FIG. 1) can connect to one or more servers of service providers in the shopping center. For example, the integrated application can connect to servers of one or more restaurants, shops, other vendors, parking lots, ice rinks, movie theaters, other entertainment venues, or any other suitable service providers of the shopping center. The integrated application can connect to the servers through communication circuitry such as communication circuitry 110 of FIG. 1.

At step 804, the integrated application can receive product information from the one or more servers connected to at step 802. For example, the integrated application can receive sales information related to a product such as how many of that product were sold within the past hour (e.g., or within the past day, or within any other suitable period of time). As another example, the integrated application can metadata related to a product such as what stores are currently carrying that product, a product description, a product brand, a product type, a product picture, or any other suitable metadata.

At step 806, the integrated application can determine the popularity of products, service providers, or both based on the information received at step 804. For example, the integrated application can compare the products in the shopping center and create a ranking of the products based on which ones are currently being purchased the most. The integrated application may then determine the popularity of the products based on this ranking. As another example, the integrated application can compare the service providers of the shopping center to determine which service providers are currently selling the most products overall. The popularity of a particular store may then be determined based on how many products it is currently selling. In this manner, the integrated application can gather real world data associated with current buying trends, and can analyze this data to determine the popularity of products, service providers, and both. The data can be analyzed by, for example, a processor such as processor 102 of FIG. 1.

At step 808, the integrated application can generate a heat map depicting the popularity rankings determine at step 806. For example, a heat map can be generated that depicts the popularity of products, service providers, or both of a shopping center. In some embodiments, various colors can be used to indicate the popularity of a product or service provider. In this case, a color key such as color key 714 of FIG. 7 can be provided to conveniently inform a user of the meaning of the various colors. In some embodiments, markers, emblems, or any other suitable indicator can be used in the heat map to define the popularity of a particular service provider, product, or both. Similar to the above illustration when colors are used, in this situation a key or legend may be provided to inform the user of meanings of the markers, emblems, or other popularity indicators.

At step 810, the heat map generated at step 808 can be displayed. For example, the heat map can be displayed on a user interface of an electronic device, such as electronic device 100 of FIG. 1.

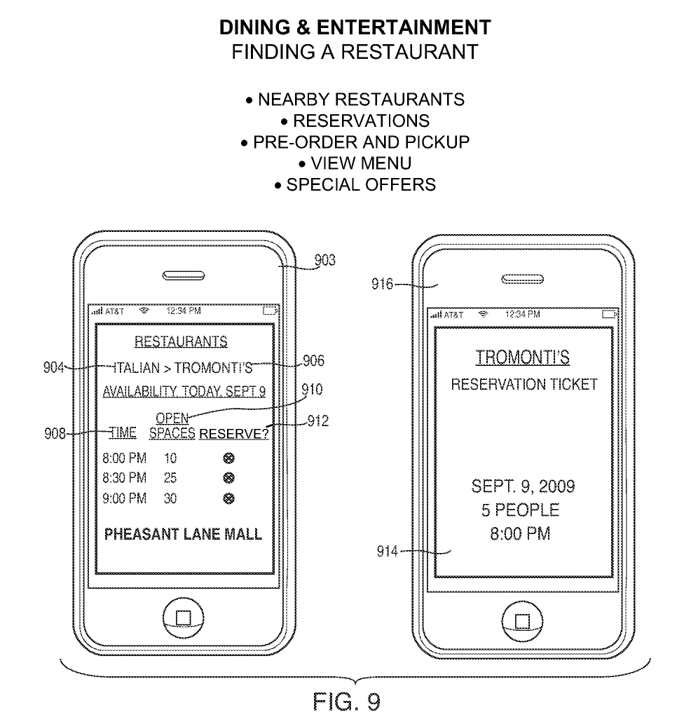

FIG. 9 is a schematic view of functions available to a user whiling dealing with restaurant service providers, entertainment service providers, or other services (e.g., at a shopping center) in accordance with some embodiments of the invention. As shown in diagram 900, a user can determine their current location with respect to the various shops in the shopping center (e.g., once connected to and authenticated by a wireless network provided by the shopping center), receive personalized maps to various restaurants and entertainment venues (e.g., using an integrated or associated mapping application) based on location, hours of operation, cuisine-types, entertainment types, user-preference, and the like.

As indicated by diagram, in some embodiments the integrated application can allow a user to make reservations at restaurants and entertainment venues in the shopping center. For example, user interface 902 shows an exemplary interface that can be generated by an integrated application on electronic device 903. Through user interface 902, a user can browse a variety of cuisine types (e.g., cuisine type 904) and restaurants. A user may then choose a particular restaurant, such as restaurant 906, to view restaurant availability 908. Restaurant availability 908 can display any suitable information related to available seating in restaurant 906 such as, for example, time of availability 910, number of open spaces 912, and selectable option 914 to enable a user to reserve a number of spaces at restaurant 906 at a particular time slot.

In some embodiments, the electronic device can allow a user to “pre-order and pickup” by functioning as a ticket for reserved items. For example, ticket 914 shows an exemplary ticket that can be saved on and displayed by electronic device 916 through the integrated application. The ticket can include any suitable markings or signals to be read or analyzed by a service provider, such as a near-field communication signal, a visual marking readable by an optical scanner (e.g., a barcode), or text that can be read by a person (e.g., a coupon). Ticket 914 can, for example, serve as proof that a user has reserved and/or paid for a particular service of the shopping center. For example, ticket 914 can serve as proof that a user has reserved a table at a restaurant, pre-ordered a product (e.g., a shirt in a certain size and style) at a store, dropped off dry cleaning at a dry cleaner in the shopping center, purchased movie tickets for a particular movie, received two free meals at a restaurant or other service provider, or has otherwise paid for or reserved a particular service at the shopping center. As another example, a user can pre-order a meal from a restaurant through a menu of the integrated application and then pickup the meal after it has been prepared (e.g., by using ticket 914 as proof of pre-ordering the meal). In some embodiments, a notification can be sent to the user through the integrated application when the meal is ready. For example, the electronic device 916 can vibrate, a text message can be sent to the user, an e-mail can be sent to the user, a push notification can be sent to electronic device 916, or any other suitable notification can be sent to the user.

As shown in diagram 900, a user may view menus and products offered by restaurants and other entertainment venues through the integrated application (e.g., by accessing a catalogue or menu through a user interface displayed on the user's electronic device). For example, a user can access menus of food available by restaurants, movies being shown by a theater, types of ice skates, lessons, or other services provided by an ice skating rink of the shopping center, or menus of other services provided by entertainment venues of the shopping center.

In some embodiments, as shown in diagram 900, a shopper can receive special offers to various restaurants that may be of interest or proximate to the user. For example, based on user preferences, coupons or promotions to restaurants and other service providers can be provided to the user through the integrated application.

In some embodiments, a user can control connectivity to in-house shopping mall entertainment offered by the shopping center provider (e.g., control power, audio, and video) that may be made available to shoppers via an in-house shopping center entertainment network. For example, games, audio channels, videos, and news, such as coupons and special announcements, may be transmitted directly to the user's electronic device over a secure network within the shopping center for the user to enjoy directly on the electronic device. In some embodiments, the electronic device can access and display, or allow for the control of a menu used to show menus of available restaurants or other services, or to show social acquaintances in the vicinity of the shopper. The electronic device can then either serve as a remote controller providing menu selections.

The process discussed above is intended to be illustrative and not limiting. Persons skilled in the art could appreciate that steps of the process discussed herein can be omitted, modified, combined, or rearranged, and any additional steps can be performed without departing from the scope of the invention.

In addition, it will be apparent to those of ordinary skill in the art that methods involved in the invention may be embodied in a computer program product that includes a machine readable and/or usable medium. For example, such a computer usable medium may consist of a read-only memory device, such as a CD ROM disk or conventional ROM device, or a random access memory, such as a hard drive device or a computer diskette, or flash memory device having a computer readable program code stored thereon.

The above-described embodiments of the invention are presented for purposes of illustration and not of limitation.

What is claimed is:

1. A portable electronic device comprising:
a display component;
communications circuitry operable to receive sales information from a server of a shopping center; and
a processor operable to:
determine a popularity level of each service provider of the shopping center based on the received sales information; and
generate a heat map indicating the determined popularity level of each service provider; and
direct the display component to display the generated heat map.

2. The portable electronic device of claim 1, wherein the generated heat map comprises:
a map of the shopping center comprising a map location of at least one service provider of the shopping center; and
at least one visual marking on the map location that indicates the popularity level of the at least one service provider.

3. The portable electronic device of claim 2, wherein the at least one visual marking comprises a particular color used to fill the map location of the at least one service provider.

4. The portable electronic device of claim 2, wherein the at least one visual marking comprises an emblem positioned on the map location.

5. The portable electronic device of claim 2, wherein the generated heat map further comprises:
a map key to inform a user of the portable electronic device of the popularity level of the at least one service provider indicated by the visual marking.

6. The portable electronic device of claim 1, further comprising:
an input device operable to receive a user request to reserve a service of the shopping center.

7. The portable electronic device of claim 6, wherein:
the user request comprises a request to reserve a particular product from a store of the shopping center; and
the communication circuitry is further operable to transmit the request to the store.

8. The portable electronic device of claim 6, wherein:
the user request comprises a request to reserve a table at a restaurant of the shopping center; and
the communication circuitry is further operable to transmit the request to the restaurant.

9. The portable electronic device of claim 6, wherein:
the user request comprises a request to place an order at a restaurant of the shopping center; and
the communication circuitry is further operable to transmit the order to the restaurant.

10. The portable electronic device of claim 9, further comprising:
a vibrating component operable to vibrate in response to the communication circuitry receiving a notification that the order is available for pick-up.

11. The portable electronic device of claim 9, wherein the communication circuitry is further operable to transmit payment information to the restaurant to pay for the order.

12. The portable electronic device of claim 9, wherein the display is further operable to display a ticket authorizing the user to pick-up the order.

13. A method comprising:
connecting to a server of at least one shopping center service provider;
receiving, from the server, product sales information associated with at least two products available at the shopping center;
determining a popularity ranking based on the received product sales information; and
generating a heat map based on the popularity ranking.

14. The method of claim 13, further comprising: displaying the generated heat map on a portable electronic device.

15. The method of claim 13, wherein the at least one shopping center service provider comprises at least one of a restaurant, a store, a vendor, a kiosk, a parking lot, a skating rink, and a movie theater of the shopping center.

16. The method of claim 13, wherein receiving product sales information comprises receiving a number of each product of the at least two products that were sold in a current period of time.

17. The method of claim 13, wherein receiving product sales information comprises receiving metadata associated with each product of the at least two products.

18. The method of claim 13, wherein:
the product sales information comprises a number of sales of each product of the at least two products; and
determining a popularity ranking comprises:
correlating the number of sales of each product to a popularity level for each product, wherein a higher number of sales is associated with a higher popularity level; and
ranking the at least two products based on the popularity level of each product.

19. The method of claim 18, wherein the generated heat map indicates the popularity level for each product.

20. The method of claim 13, wherein determining a popularity ranking comprises:
determining a popularity level for each service provider of at least two service providers of the shopping center; and
ranking each service provider based on the determined popularity level of each service provider.

21. The method of claim 20, wherein:
the product sales information comprises:
a number of sales of each product of the at least two products within a current period of time; and
a designation of a service provider that sold each product; and
determining a popularity level for at least two service providers of the shopping center comprises:
determining, for each service provider, a total number of sales of products sold by each service provider within the current period of time; and
determining a popularity level for each service provider based on its total number of sales, wherein a higher number of sales is associated with a higher popularity level.

22. The method of claim 20, wherein the generated heat map indicates the popularity level of each service provider.

23. Machine-readable media comprising machine-readable instructions recorded thereon for:
connecting to a server of at least one shopping center service provider;
receiving product sales information associated with at least two products available at the shopping center;
determining a popularity ranking based on the received product sales information; and
generating a heat map based on the popularity ranking.

24. The machine-readable media of claim 23, further comprising machine-readable instructions recorded thereon for:
displaying the generated heat map on a portable electronic device.
